(19) United States
(12) Patent Application Publication
(10) Pub. No.: US 2020/0327818 A1
(43) Pub. Date: Oct. 15, 2020

(54) INTERLEAVED TRAINING AND TASK SUPPORT

(71) Applicant: International Business Machines Corporation, Armonk, NY (US)

(72) Inventors: Donna K. Byron, Petersham, MA (US); Mary D. Swift, Rochester, NY (US); Jennifer Nolan, Toronto (CA); Elezaveta Koumpan, Stoney Creek (CA)

(21) Appl. No.: 16/382,176

(22) Filed: Apr. 11, 2019

(51) Int. Cl. G09B 5/12; G06Q 10/06; G06Q 10/10; G09B 19/00; G09B 5/04; G10L 13/04

(52) U.S. Cl. CPC G09B 5/12; G06Q 10/06316; G10L 13/043; G09B 19/00; G09B 5/04; G06Q 10/1097

(57) ABSTRACT

An interleave module interleaves training and task support to assist a user to complete a task while simultaneously providing training to the user. The interleave module helps the user work towards a desired state using a task knowledge base while interjecting appropriate training based on need, the user's mental state and timing constraints. The interleave module may use a variety of input sensors for a subject and the agent to help determine actions to be taken to achieve the task goals and the user's mental state for training.

### BACKGROUND

### 1. Technical Field

This disclosure generally relates to computer processing, and more specifically relates to a system and method for interleaved training and decision support for a user performing a task.

### 2. Background Art

A conversational training system or conversation agent is a computer system intended to converse with a human user with a coherent structure for training or teaching the user. The training may include teaching the user to perform a specific task. Dialogue training systems have employed text, speech, graphics, gestures, and other modes for communication on both the input and output channel. Conversations with tutoring dialog training systems typically take place completely within a training context (in-class educational settings or military training simulations).

A decision support system or task manager is a computer system intended to converse with a human user to assist the user to perform a specific task. In a task manager system the computer system is the expert that assists the user to perform a specific task. Conversations with an expert task manager system typically take place within a work or performance setting.

A conversational training system typically includes a dialog manager that manages the state of the dialog with the user. The user's input is recognized by an automatic speech recognizer and analyzed. The dialog manager keeps a history of the dialog and manages the flow of the conversation. The dialog manager may seek input from a task manager that has knowledge of the specific task domain of the training. The dialog manager may then generate an output to the user which may then be rendered to the user in an appropriate form such as a text-to-speech engine.

### BRIEF SUMMARY

A system and method interleaves training and task support to assist a user to complete a task while simultaneously providing training to the user. An interleave module helps the user work towards a desired state using a task knowledge base while interjecting appropriate training based on need, the user's mental state and timing constraints. The interleave module may use a variety of input sensors for a subject and the agent to help determine actions to be taken to achieve the task goals and the user's mental state for training.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a block diagram of a computer system with an interleave module for a dialog manager that that interleaves training and task support to assist a user to complete a task;

FIG. 2 illustrates a simplified block diagram of a conversation training system with an interleave module in a dialog manager that interleaves training and task support to assist a user to complete a task;

FIG. 3 is flow diagram of an example method that interleaves training and task support to assist a user to complete a task;

FIG. 4 is a flow diagram of an example of step 330 in FIG. 3 for interleaving training and task support to assist a user to complete a task; and

FIGS. 5A-D illustrate task recipes for an example of interleaving training and task support to assist a user to complete a task.

### DETAILED DESCRIPTION

The disclosure and claims herein relate to a system and method that interleaves training and task support to assist a user to complete a task while simultaneously providing training to the user. An interleave module helps the user work towards a desired state using a task knowledge base while interjecting appropriate training based on need, the user's mental state and timing constraints. The interleave module may use a variety of input sensors for a subject and the agent to help determine actions to be taken to achieve the task goals and the user's mental state for training.

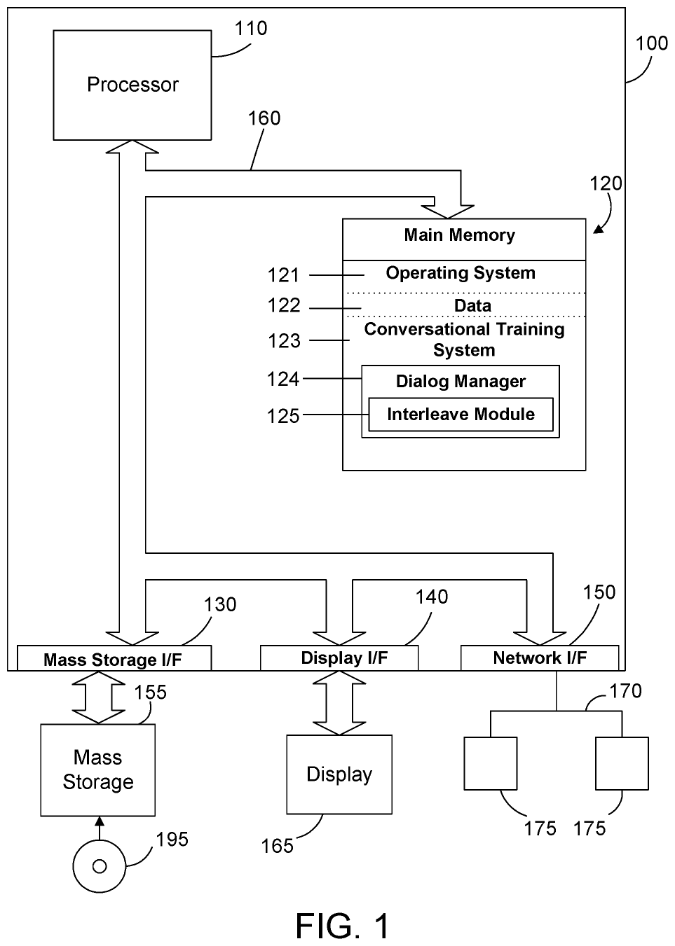

Referring to FIG. 1, a computer system 100 is one suitable implementation of a computer system that is capable of performing the computer operations described herein including scanning an interleave module in a dialog manager that interleaves training and task support to assist a user to complete a task. Computer system 100 is a computer which can run multiple operating systems including the IBM i operating system. However, those skilled in the art will appreciate that the disclosure herein applies equally to any computer system, regardless of whether the computer system is a complicated multi-user computing apparatus, a single user workstation, laptop, phone or an embedded control system. As shown in FIG. 1, computer system 100 comprises one or more processors 110. The computer system 100 further includes a main memory 120, a mass storage interface 130, a display interface 140, and a network interface 150. These system components are interconnected through the use of a system bus 160. Mass storage interface 130 is used to connect mass storage devices with a computer readable medium, such as mass storage 155, to computer system 100. One specific type of mass storage 155 is a readable and writable CD-RW drive, which may store data to and read data from a CD-RW 195. Some mass storage devices may have a removable memory card or similar instead of the CD-RW drive.

Main memory 120 preferably contains an operating system 121 and data 122. Operating system 121 is a multitasking operating system known in the industry as IBM i; however, those skilled in the art will appreciate that the spirit and scope of this disclosure is not limited to any one operating system. Data 122 may include any data stored or used in computer system 100. The memory 120 further includes a conversational training system 123 with a dialog manager 124. The dialog manager 124 includes an interleave module that interleaves training and task support to assist a user to complete a task as described herein.

Computer system 100 utilizes well known virtual addressing mechanisms that allow the programs of computer system 100 to behave as if they only have access to a large, single storage entity instead of access to multiple, smaller storage entities such as main memory 120 and mass storage 155. Therefore, while operating system 121, data 122, conversational training system 123, dialog manager 124 and the interleave module 125 are shown to reside in main memory 120, those skilled in the art will recognize that these items are not necessarily all completely contained in main memory 120 at the same time. It should also be noted that the term “memory” is used herein generically to refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 121 and later executes the program instructions that make up the conversational training system 123.

Although computer system 100 is shown to contain only a single processor and a single system bus, those skilled in the art will appreciate that the system may be practiced using a computer system that has multiple processors and/or multiple buses. In addition, the interfaces that are used preferably each include separate, fully programmed microprocessors that are used to off-load compute-intensive processing from processor 110. However, those skilled in the art will appreciate that these functions may be performed using I/O adapters as well.

Display interface 140 is used to directly connect one or more displays 165 to computer system 100. These displays 165, which may be non-intelligent (i.e., dumb) terminals or fully programmable workstations, are used to provide system administrators and users the ability to communicate with computer system 100. Note, however, that while display interface 140 is provided to support communication with one or more displays 165, computer system 100 does not necessarily require a display 165, because all needed interaction with users and other processes may occur via network interface 150, e.g., web client based users.

Network interface 150 is used to connect computer system 100 to other computer systems or workstations 175 via network 170. Network interface 150 broadly represents any suitable way to interconnect electronic devices, regardless of whether the network 170 comprises present-day analog and/or digital techniques or via some networking mechanism of the future. In addition, many different network protocols can be used to implement a network. These protocols are specialized computer programs that allow computers to communicate across a network. TCP/IP (Transmission Control Protocol/Internet Protocol) is an example of a suitable network protocol.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The invention described herein can be utilized in any workflow where a person has time-sensitive actions to perform, where their cognitive load varies due to being overwhelmed by tasks, sleep deprivation or because they are undergoing normal cognitive decline due to aging or dementia, and in which training and skill development are crucial for ongoing goal attainment. Domestic scenarios include childcare, eldercare, and any skilled communication. Professional scenarios that exhibit the above characteristics and may utilize the invention include retail managers, camp counselors, classroom teachers, field technicians such as heavy equipment operators or monitoring stations, public safety workers like neighborhood police officers, or even more acute scenarios such as a medical doctor field team delivering care in a new cultural or language context. A feature of the conversational training system with the interleave module described herein is the ability to interleave prioritized goals and converse about problem solving in a way that is sensitive to the trainee's mental state. An example embodiment described herein is a school administrator. It is anticipated that the dialogue partner for the conversational training system as described herein is both the user of the system and the trainee.

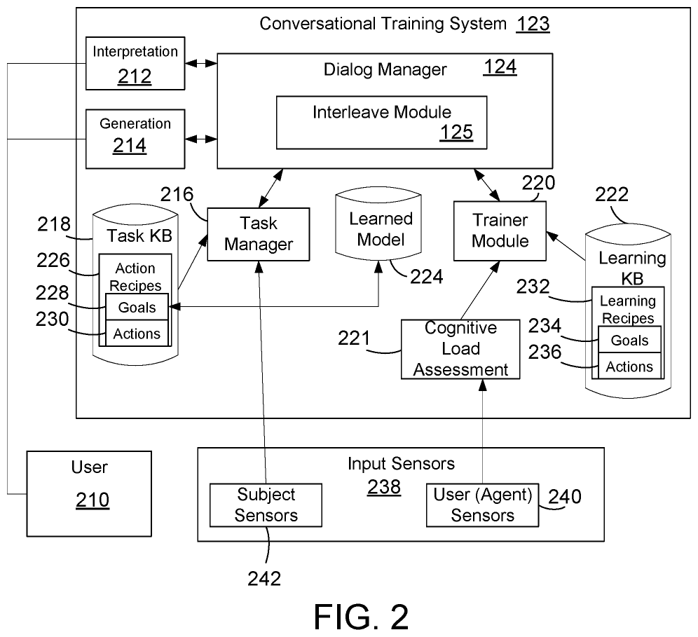

FIG. 2 illustrates a simplified block diagram of one suitable implementation for the conversational training system 123 with an interleave module 125 shown in FIG. 1. The conversation training system is sometimes referred to in the art as an “agent”. In this example, the interleave module 125 is part of a dialog manager 124. The dialog manager 124 manages the state of the dialog with a user 210. The user's input is analyzed and recognized by an automatic speech recognizer shown as interpretation unit 212. The dialog manager 124 keeps a history of the dialog and manages the flow of the conversation. During training or task actions, the dialog manager 124 may seek input from a task manager that has knowledge of the specific task domain of the training. The dialog manager 124 may then generate an output to the user 210 which may then be rendered to the user in an appropriate form such as a text-to-speech by the generation unit 214.

Again referring to FIG. 2, the conversational training system 123 further includes a task manager 216 connected to the dialog manager that manages upcoming tasks for the user 210 using a task knowledge base 218. In addition, a trainer module 220 provides training support to the dialog manager using a learning knowledge base 222. The system utilizes the learned model 224 to record the user/trainee's skill level at different tasks within the domain, e.g. those skills that the user has already mastered and those that need more practice. The task knowledge base 218 includes action recipes 226 for user tasks with corresponding goals 228 and actions 230. Similarly, the learning knowledge base 222 includes learning recipes 232 for user training with corresponding goals 234 and actions 236. Goals 228 and 234 represent a desired state for the task or learning respectively and may include a desired completion time. The actions 230, 236 represent things needed to achieve the corresponding goal of the recipe. The task recipes 226 may include a skill level as a pre-condition for the action that will be considered by the dialog manager when analyzing and selecting a task goal for the user. Similarly, the learning recipes 232 may include a knowledge difficulty level as a pre-condition considered by the dialog manager when analyzing and selecting a learning goal for the user.

In collaborative dialog systems such as the conversational training system 123 described herein, the dialog manager 124 is the component that assesses the current situation (both sensors and discourse history) to choose a next best communication action to send to the user 210. The dialog manager 124 with the task manager 216 determines the next best task depending on an action inventory in the task knowledge base. The task knowledge base 218 includes action recipes 226 that pair goal states (a declarative description of a desired set of attribute value pairs) with the action sequences that lead to that state. The action recipes modeled in the task are nodes with known preconditions/postconditions that can be assembled into workflows to address particular goals as known in the prior art. The inventory of action recipes may include multiple ways of achieving each goal. The inventory includes both primary task goals in the task knowledge base 218 and learning goals within the learning knowledge base 222. Additionally, for each action the user might perform, there is an indication of skill level required, or possibly preconditions of skill-attainment states by the trainee, and also the level of intensity of the task or some notion of how much cognitive load is required, and also the expected time required to perform the action. The cognitive load of the user may be determined by a cognitive load assessment block 221. The cognitive load assessment block 221 inputs data from the sensors (described below) to assess the alertness and cognitive load of the trainee/user and report an alertness assessment to the interleave module and the dialog manager. The cognitive load feature can be used to select among alternate actions that achieve a particular goal, based on the trainees observed attention state. Additionally, the task goals have priority levels so that the decision process can adjudicate between competing tasks and deadlines. Priorities could be set based on hierarchy-of-needs values, other parameters estimated via machine learning, or can be adjusted dynamically due to some ongoing situation such as emergency response.

The conversational training system 123 may use a number of input sensors 238 to provide input concerning the state of the situation and task being completed, the state of system components such as the responsiveness of communication infrastructure, and also the state of those persons or entities associated with the training/task workflow environment being supported by the conversational training system 123. In this example, the input sensors includes user sensors 240 that sense the state of the user 210, and subject sensors 242 that sense the state of a subject entity such as a child, elderly person that is the subject of a task being performed by the user. Input sensors 238 could include sensors for the mental state of the user 210 and a subject (not shown) such as alertness level and body biometrics. The sensors could include active monitoring devices worn by the trainee to measure the biometrics. The biometrics could include such things as heart rate, respiration rate, sleep history, etc. In addition, passive sensors could be used such as cameras or iris-scanners. The sensors could provide the alertness level by monitoring tone, and lag time of speech. The dialog manager could also use direct requests to the user to report the user's mental and physical state.

The interleave module described herein is preferably part of a dialog manager of a conversational training system that interleaves training and task support to assist a user to complete a task. The interleave module may poll one or more available sensors and gather data for a situational assessment. The situational assessment includes the mental and physical state of the user, and the user's schedule. A variety of sensors can be used to provide the situational assessment such as the sensors described above. The interleave module compares the current time to scheduled task goals and looks for unscheduled but high priority goal to determine the next primary task goal. Where possible, the interleave module will interleave dialog for the primary task goal with a learning goal as described herein and then communicate results of the task to the user and update the system state and trainee skill database based on the completed task. Thus the trainer module 220 can observe the completed learning task goal with sensors 238 and through the link back to the dialog manager 124 communicate an assessment of the learning activity to the user. The completed task goals 228 can be used to update the learned model 224.

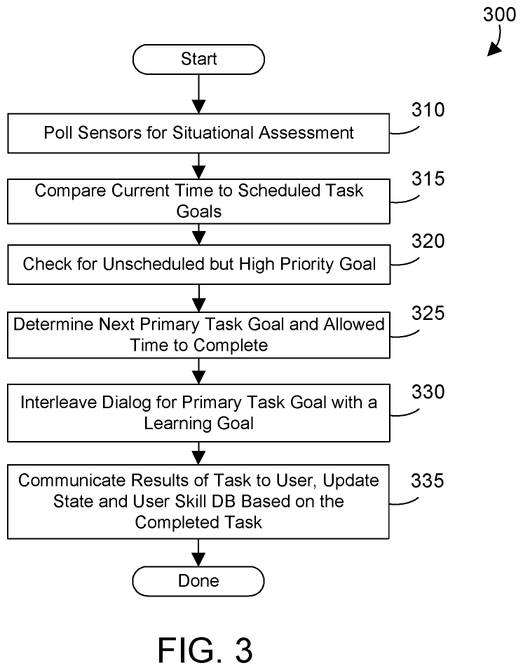

Referring to FIG. 3, a method 300 shows one suitable example for an interleave module for a dialog manager that interleaves training and task support to assist a user to complete a task. Portions of method 300 are preferably performed by the interleave module 125, the dialog manager 124 and other parts of the conversational training system 123 shown in FIG. 2. First, poll available sensors and gather data for a situational assessment (step 310). Next, compare the current time to scheduled task goals (step 315). Check for an unscheduled but high priority goal (step 320). Determine the next primary task goal and allowed time to complete (step 325). Where possible, interleave dialog for the primary task goal with a learning goal (step 330). Communicate results of the task to the trainee, update the system state and trainee skill database based on the completed task (step 335). Method 300 is then done.

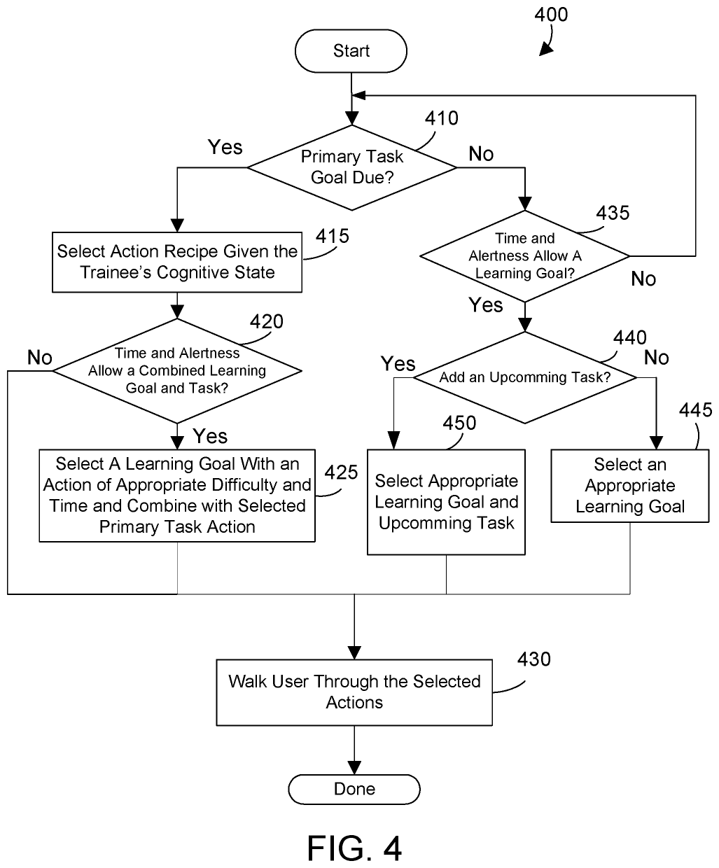

Referring to FIG. 4, a method 400 shows a suitable example for interleaving dialog for the primary task goal with a learning goal. Method 400 thus shows a suitable example for performing step 330 in method 300 shown in FIG. 3. First, determine if a primary task goal is due (step 410). If there is a primary task goal due (step 410=yes) then select an action recipe given the trainee's cognitive state (step 415). Next, determine if time and alertness of the trainee allow a combined learning goal and the primary task (step 420). If there is time and alertness sufficient for a combined learning goal and the primary task (step 420=yes) then select a learning goal with an action of appropriate difficulty and time and combine with the selected primary task action (step 425). Then walk the trainee through the selected actions (step 430). If there is not time and alertness sufficient for a combined learning goal and the primary task (step 420=no) then go to step 430 and walk the trainee through the selected actions (step 430). If there is no primary task goal due (step 410=no) then determine if time and alertness of the trainee allow a learning goal (step 435). If time and alertness of the trainee do not allow for a learning goal (step 435=no) then return to step 410. If time and alertness of the trainee do allow for a learning goal (step 435=yes) then determine whether to add an upcoming task (step 440). If an upcoming task cannot be added (step 440=no) then select an appropriate goal (step 445) and walk the trainee through the selected actions (step 430). If an upcoming task can be added (step 440=yes) then select an appropriate learning goal and an upcoming task (step 450) and walk the trainee through the selected actions (step 430). Method 400 is then done.

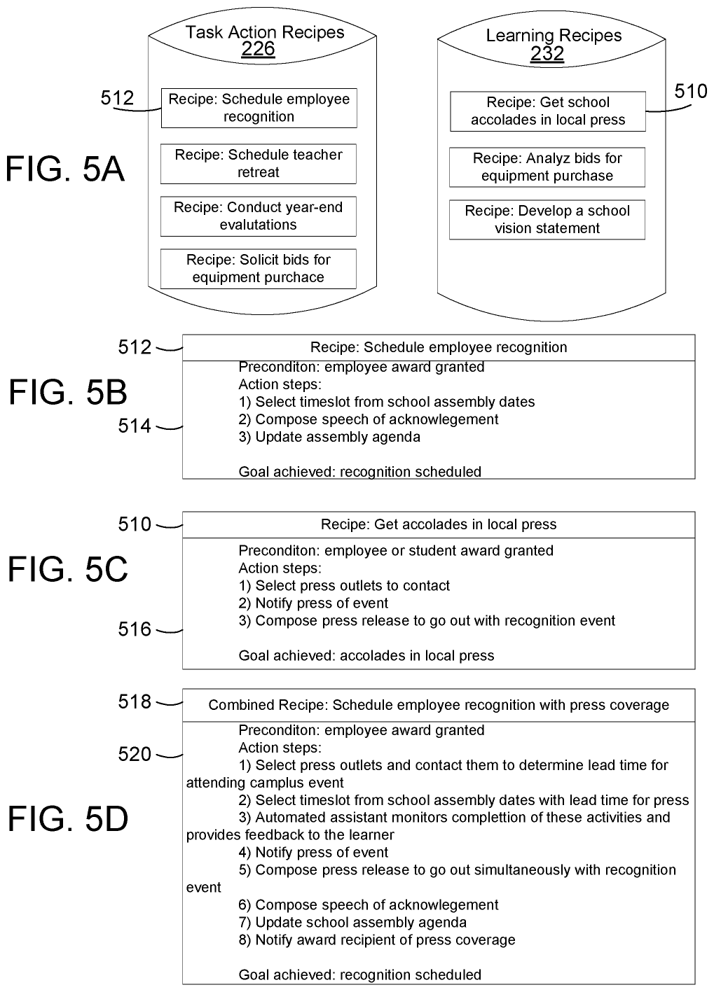

We will now consider two examples of interleaving training and task support to assist a user to complete a task. In these examples, a dialog manager interleaves training and task support where the user/trainee is a school administrator such as a school principal. In the examples, the school administrator must juggle both scheduled and unscheduled tasks, handle emergencies as they arise and keep gaining skills toward career advancement. For many tasks, there are simpler vs. more complex ways to arrive at a goal and also times when new skills can be practiced to achieve his/her own learning goals. First the school administrator's automated assistant dialog manager determines if a primary task goal is due in the next time slice (step 410). We will then consider an example of a task not due and an example of a task due (taking either branch from step 410 in FIG. 4). In the first example, we will use the task action recipes 226 and the learning recipes as shown in FIG. 5A.

In a first example, it is determined that the administrator has no primary task goal that is due in the next time window (step 410=no). The system determines whether there is time and alertness for a learning goal. If there is not time or alertness for a learning goal the system waits (return to step 410). In this example, we assume that the system determines there is sufficient alertness and the user has 2 hours available for a learning activity (step 435). The system then determines whether there is an upcoming task goals that must be satisfied in the near future that can be combined with a learning goal (step 440). In this example, a learning goal and activity needs to be selected from the library. Selection can be triggered by an identified skill gap, something the user did poorly on recently, or a skill that needs to be improved, such as improvement areas from last year's career discussion. If a learning goal is found without a related upcoming task the system may select an appropriate learning goal and walk the user through actions of the selected learning goal (step 445, 430).

Continuing the first example, the system identifies an upcoming task and selects an appropriate learning goal to combine it with the upcoming task (step 450,430). If we assume 2 hours are available, the system may choose a task with several components aligned with the learning goal described as ‘Get school accolades in the local press’ 510. Further, an upcoming task that must be completed within the week is to schedule a teaching award recognition ceremony at a school assembly for a teacher who won a state teaching excellence award 512. The recipe steps 514 for scheduling the employee recognition are shown in FIG. 5B. The recipe steps 516 for getting school accolades in the local press are shown in FIG. 5C. The system combines and interleaves the learning recipe 510 and the task action recipes 512 to create a combined recipe 518 with interleaved steps 520 in FIG. 5D. The dialog manager then takes the principal user through the combined recipe steps 520 to perform the primary activity with additional tasks to serve the learning goal. The combined task recipe 512 and learning recipe 510 actions combined may include the steps as shown in FIG. 5D.

In the first example, the conversational agent constructed a complex workflow to achieve the goal of getting press coverage of a school event. Because the learned model 224 (representing skills that the principal has already mastered) shows a skills gap in this area, the interleave module 125 walks the principal through several additional tasks such as gathering information about the required lead time for the various press outlets. The training component monitors task completion and offers feedback for these actions within the larger plan. In this way, the primary task goal to recognize the teacher's award is achieved, as well as a secondary task goal to have press coverage of the event, and a learning activity was completed so that the principal now understands the process of inviting press to a school event. Within this combined recipe workflow 520, steps 1, 4 and 5 were introduced by the training module, steps 2 and 6 were modified due to interleaving the primary and learning goals, and the dialogue between the principal and the conversational agent included feedback or assessment of the principal's completion of novel skills in steps 1, 4 and 5.

In a second example, it is determined that the administrator has a primary task goal that is due (step 410=yes in FIG. 4). The primary task goal due is that teacher evaluations must be distributed to students by the end of the day. The administrator's cognitive state is assessed to see whether a learning goal can be combined with the task. One or more sensors may be checked to determine the administrator's cognitive state. Due to a stressful conversation with a parent earlier, the system concludes that a simple task is best. The task recipe may include the following actions. Contact the assistant and check if paper evaluations have been copied and distributed. If not already done, remind administrative assistant to perform the task, and place a notification on his schedule for 14:00 to confirm with the assistant that the task was completed.

Alternatively, if the cognitive state of the principal is not overwhelmed, meaning a low cognitive load is detected, then the interleave module calculates whether a more complex task which includes a learning goal can still be completed by the deadline (step 420). This block finds that a learning activity requiring no more than 20 additional minutes can be interleaved. A learning goal with an action of appropriate difficulty and time is selected and combined with the primary task action. The combined task and learning goal recipe is then prompted to the user. In this example, the interleave module scans the list of learning goals and finds an entry stating a goal of ‘improve teacher morale’. A learning activity expected to improve this skill for the principal is retrieved from the learning recipes knowledge base 232. In this example, the recipe has an abstract precondition stating that a mandatory process must be executed by the administrator's subordinate. Further, the recipe is instantiated specifically that “student teacher evaluations process must be completed by the teachers”. The steps in the example recipe may include: send a note to the subordinate, along with the assigned process, explaining how the process (in this case student feedback) helps the subordinate's career. Continuing to step 425, the dialog manager walks the principal through creation of a hand-written note to send to teachers along with the evaluations, requesting that the teachers be open to feedback and reminding them why student evaluations are important to their own careers. The dialog manager with the interleave module walks the administrator through the creation of the accompanying note with tips about helpful language. Continuing with the recipe steps the principal sends the assistant the evaluations along with his note to distribute. After finishing interleaving the task and learning goals, the process may continue with step 335 shown in FIG. 3. Here, the system records the fact that the user completed an action with improving teacher morale as its goal (the learning goal) in the learned model knowledge base 218 and also records completion of the primary task goal to distribute the evaluations. The process is completed (DONE step).

The claims and disclosure herein support an apparatus comprising: at least one processor; a memory coupled to the at least one processor; and an interleave module residing in the memory and executed by the at least one processor, wherein the interleave module interleaves dialog for a primary task goal with dialog for a learning goal to assist a user to complete a task while simultaneously providing training to the user.

The claims and disclosure herein further support a computer-implemented method executed by at least one processor comprising: providing a conversational training system for a user; interleaving dialog for a primary task goal with dialog for a learning goal to assist the user to complete a task while simultaneously providing training to the user.

The claims and disclosure herein additionally support a computer-implemented method executed by at least one processor for providing a conversational training system comprising: polling a plurality of sensors for situational assessment; comparing a current time to scheduled task goals in a task knowledge base; checking for unscheduled but high priority goal; determining a next primary task goal and allowed time to complete; interleaving dialog for a primary task goal with dialog for a learning goal to assist a user to complete a task while simultaneously providing training to the user depending on a situational assessment of the user from the plurality of sensors; wherein the task knowledge base includes action recipes for user tasks with corresponding goals and actions; and wherein when a primary task goal is due and time and alertness allow a combined learning goal and primary task, then a learning goal of appropriate difficulty and time is combined with a primary task, and the user is walked through combined actions by interleaving dialog for the primary task goal with the learning goal.

An interleave module for a dialog manager is described that interleaves training and task support to assist a user to complete a task. The interleave module helps the user work towards a desired state using a task knowledge base while interjecting appropriate training based on need, the user's mental state and timing constraints. The described interleave module increases the user's productivity and efficiency by combining training and task support.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1. An apparatus comprising:
at least one processor;
a memory coupled to the at least one processor; and
an interleave module residing in the memory and executed by the at least one processor, wherein the interleave module interleaves dialog for a primary task goal with dialog for a learning goal to assist a user to complete a task while simultaneously providing training to the user.

2. The apparatus of claim 1 wherein the interleave module determines whether to interleave dialog for the primary task with a learning goal depending on a situational assessment of the user after polling a plurality of sensors.

3. The apparatus of claim 1 wherein the interleave module compares a current time to scheduled task goals to determine a primary task goal and allowed time to complete the primary task goal.

4. The apparatus of claim 1 further comprising a task manager coupled to a task knowledge base that includes action recipes for user tasks with corresponding goals and actions.

5. The apparatus of claim 1 further comprising a trainer module coupled to a learning knowledge base that includes learning recipes for user training with corresponding goals and actions.

6. The apparatus of claim 4 further comprising subject sensors that provide input to the task manager.

7. The apparatus of claim 5 further comprising agent sensors that provide input to the training module.

8. The apparatus of claim 7 wherein the interleave module is part of a dialog manager in a conversational training system.

9. A computer-implemented method executed by at least one processor comprising:
providing a conversational training system with decision support for a user to complete a task;
interleaving dialog for a primary task goal with dialog for a learning goal to assist the user to complete a task while simultaneously providing training to the user.

10. The method of claim 9 further comprising:
polling a plurality of sensors for situational assessment;
comparing a current time to scheduled task goals in a task knowledge base;
checking for unscheduled but high priority goal;
determining a next primary task goal and allowed time to complete; and
after interleaving dialog for the primary task goal with a learning goal, communicating results of task to the user.

11. The method of claim 10 wherein the step to interleave dialog for the primary task with a learning goal depends on a situational assessment of the user after polling the plurality of sensors.

12. The method of claim 10 wherein the task knowledge base includes action recipes for user tasks with corresponding goals and actions.

13. The method of claim 10 further comprising a learning knowledge base that includes learning recipes for user training with corresponding learning goals and actions.

14. The method of claim 10 wherein when a primary task goal is due and time and alertness allow a combined learning goal and primary task, then a learning goal of appropriate difficulty and time is combined with a primary task, and the user is walked through combined actions by interleaving dialog for the primary task goal with the learning goal.

15. The method of claim 10 wherein when a primary task goal is not due, time and alertness allow a learning goal and an upcoming task can be added, then a learning goal of appropriate difficulty and time is combined with the upcoming task, and the user is walked through combined actions by interleaving dialog for the upcoming task goal with the learning goal.

16. The method of claim 9 wherein when a primary task goal is not due, time and alertness allow a learning goal and an upcoming task cannot be added, then a learning goal of appropriate difficulty and time is selected, and the user is walked through the learning goal.

17. A computer-implemented method executed by at least one processor for providing a conversational training system comprising:
polling a plurality of sensors for situational assessment;
comparing a current time to scheduled task goals in a task knowledge base;
checking for unscheduled but high priority goal;
determining a next primary task goal and allowed time to complete;
interleaving dialog for a primary task goal with dialog for a learning goal to assist a user to complete a task while simultaneously providing training to the user depending on a situational assessment of the user from the plurality of sensors;
wherein the task knowledge base includes action recipes for user tasks with corresponding goals and actions; and
wherein when a primary task goal is due and time and alertness allow a combined learning goal and primary task, then a learning goal of appropriate difficulty and time is combined with a primary task, and the user is walked through combined actions by interleaving dialog for the primary task goal with the learning goal.

18. The method of claim 17 further comprising a learning knowledge base that includes learning recipes for user training with corresponding learning goals and actions.

19. The method of claim 17 wherein when a primary task goal is not due, time and alertness allow a learning goal and an upcoming task can be added, then a learning goal of appropriate difficulty and time is combined with the upcoming task, and the user is walked through combined actions by interleaving dialog for the upcoming task goal with the learning goal.

20. The method of claim 17 wherein when a primary task goal is not due, time and alertness allow a learning goal and an upcoming task cannot be added, then a learning goal of appropriate difficulty and time is selected, and the user is walked through the learning goal.
